(19) United States
(12) Patent Application Publication
(10) Pub. No.: US 2023/0409676 A1
(43) Pub. Date: Dec. 21, 2023

(54) EMBEDDING-BASED OBJECT CLASSIFICATION SYSTEM AND METHOD

(71) Applicant: HYUNDAI MOBIS CO., LTD., Seoul (KR)

(72) Inventor: Jae Young LEE, Icheon-si (KR)

(73) Assignee: HYUNDAI MOBIS CO., LTD., Seoul (KR)

(21) Appl. No.: 18/146,398

(22) Filed: Dec. 26, 2022

(30) Foreign Application Priority Data
Jun. 21, 2022 (KR) 10-2022-0075577

(51) Int. Cl. G06F 18/2413

(52) U.S. Cl. CPC G06F 18/2413

(57) ABSTRACT

Provided are an embedding-based object classification system and method for implementing a classification network in a smaller memory usage amount and a smaller computation amount than the conventional art, such that the classification network is applicable to an embedded system even if the classification network has complicated class information.

### CROSS-REFERENCE TO RELATED APPLICATIONS

This application claims priority under 35 U.S.C. § 119 to Korean Patent Application No. 10-2022-0075577, filed on Jun. 21, 2022, in the Korean Intellectual Property Office, the disclosure of which is incorporated herein by reference in its entirety.

### TECHNICAL FIELD

The following disclosure relates to an embedding-based object classification system and method, and more particularly, to an embedding-based object classification system and method designed to be implemented in an embedded system with a limited memory usage amount and a limited computation amount, while classifying an object after recognizing an object area included in image data.

### BACKGROUND

Traffic signs are notice boards for indicating cautions, regulations, instructions, and the like necessary for traffic. In order for autonomous vehicles to obey road rules, it is necessary to recognize signs because road conditions change according to circumstances.

In order to recognize a sign included in input image data, it is needed to find a sign area in the input image data as a first step, and then classify a sign corresponding to the found sign area as a second step.

With the recent development of deep learning technology, there has been an improvement in object recognition performance. In addition, as neural processing units (NPUs) or the like are mounted on application processors (APs) or the like, deep learning networks have been increasingly applied to forward cameras.

In order to recognize a traffic sign, such a deep learning network finds a candidate area (a bounding box) of the traffic sign using an object detection network, and then classifies the detected traffic sign to determine what meaning the traffic sign has using a classification network.

However, traffic signs are easy to recognize because their images are generated by a computer, but the classification network is difficult to implement in an embedded system because there are so many types of traffic signs, which has remained a problem.

Specifically, even in an embedded system supporting deep learning, a weight value and a computation amount of a network are limited due to a small cache memory capacity and constraints on real-time processing.

For example, a “TDA4V-MID processor” manufactured by TI provides a cache memory of 8 MB, but needs to operate multiple networks in parallel, and thus, a memory size available for a single network is about 2 MB. In particular, in order to recognize a sign, the two networks operate in the limited memory, because the object detection network needs to extract a candidate area of the traffic sign and the classification network needs to perform a specific classification operation. Furthermore, the classification network repeats the operation as many times as the number of candidate areas, and the number of traffic signs is usually 300 or more. Therefore, a memory size used by two fully-connected (FC) layers included at the end of the classification network is 0.7 MB (300*300*4B*2).

Since 35% of the memory is consumed by only the two layers as described above, it is exceedingly difficult to implement a network (an edge network) for recognizing signs in an embedded system.

In addition, since a computation amount consumed by the two layers is 175 kFlops, when a plurality of candidate areas are extracted, there is a problem that it is not possible to satisfy real-time processing conditions.

At autonomous driving level 2, autonomous driving control is not performed at full scale, and driver's control is essentially involved. Thus, although only speed signs, which are very few of the traffic signs, are recognized and classified through the autonomous driving control at the autonomous driving level 2, this may provide great help to drivers.

However, at autonomous driving level 3 or higher, a driver does not intervene in a driving process. It is thus necessary to recognize and classify most traffic signs located on roads including not only simple speed signs but also construction site signs with which road shapes are highly likely to be changed, but this is difficult to implement in an in-vehicle embedded system, which is actually acting as a problem in increasing the autonomous driving level.

Korean Patent Laid-Open Publication No. 10-2020-0003349 (entitled “TRAFFIC SIGN RECOGNITION SYSTEM AND METHOD”) provides a traffic sign recognition system and method using a technology for minimizing a computational load on a processor.

### SUMMARY

An embodiment of the present invention is directed to providing an embedding-based object classification system designed to implement an object classification network in an embedded system in which a memory usage amount and a computation amount are limited because of hundreds of different classes of objects, which cause constraints in implementing the object classification network in the embedded system, although it is easy to recognize object areas.

In one general aspect, an embedding-based object classification system includes: a first learning-processing unit performing learning by inputting a set of learning data labeled with class information for objects to a pre-stored classification network; a second learning-processing unit configuring a classification network based on a learning result of the first learning-processing unit, and performing learning by inputting the set of learning data to the classification network; and an inference processing unit classifying an object included in input image data and outputting class information for the object, using the classification network subjected to final learning-processing by the second learning-processing unit.

The classification network of the first learning-processing unit may include: a feature extraction unit including a plurality of convolution layers and a plurality of pooling layers to extract features of the set of learning data; a classification processing unit including at least two fully-connected (FC) layers to determine a class of each of the extracted features; and an output function unit including a preset activation function layer to output the determined class as an output value, and the first learning-processing unit may update and set weights for the layers of the feature extraction unit and the classification processing unit, based on the output value, using a preset loss function and a preset optimization technique.

The classification network of the second learning-processing unit may include: a feature extraction unit including a plurality of convolution layers and a plurality of pooling layers to extract features of the set of learning data; a classification processing unit includes at least two FC layers to determine a class of each of the extracted features; an output function unit including a preset activation function layer to output the determined class as an output value; and an embedding processing unit including at least one embedding layer to receive the set of learning data and convert the set of learning data into real-number parameters in a preset number of dimensions, the weights set in a last (or most recent) update by the feature extraction unit of the first learning-processing unit may be applied to the layers of the feature extraction unit of the second learning-processing unit, and the second learning-processing unit may update and set weights for the layers of the classification processing unit and the embedding processing unit of the second learning-processing unit, using a preset loss function and a preset optimization technique.

The classification processing unit of the second learning-processing unit may configure the layers in a smaller number of dimensions than the classification processing unit of the first learning-processing unit.

The inference processing unit may include: an input unit inputting image data from which an object to be classified is recognized; an output unit outputting a predicted class of the object in the image data input by the input unit to the classification network subjected to final learning-processing by the second learning-processing unit; a mapping unit performing mapping analysis by mapping a value output by the data output unit to a weight value for the embedding processing unit subjected to final learning-processing by the second learning-processing unit; and an inference unit determining and outputting a final class of the object using a mapping analysis result of the mapping unit.

In another general aspect, an embedding-based object classification method using an embedding-based object classification system operated by an arithmetic processing means to perform each step includes: a first learning step (S100) of performing learning by inputting a set of learning data labeled with class information for objects to a classification network; a second learning step (S200) of configuring a classification network based on a learning result of the first learning step (S100), and performing learning by inputting the set of learning data to the classification network; and an inference processing step (S300) of, when an object to be classified is recognized from image data input from an external source, classifying the object included in the image data and outputting class information for the object, using the classification network subjected to final learning-processing in the second learning step (S200).

The classification network in the second learning step (S200) may be configured by applying weights for a plurality of convolution layers and a plurality of pooling layers constituting the classification network subjected to final learning-processing in the first learning step (S100), and the classification network in the second learning step (S200) may include at least one embedding layer such that the set of learning data is input to the embedding layer to convert the set of learning data into real-number parameters in a preset number of dimensions and output the real-number parameters in the preset number of dimensions.

The classification network in the second learning step (S200) may include fully-connected (FC) layers in a smaller number of dimensions than the classification network in the first learning step (S100).

The inference processing step (S300) may include: outputting a predicted class of the object in the image data from the classification network subjected to final learning-processing in the second learning step (S200); and performing mapping analysis by mapping the output predicted class to a weight value for the embedding layer subjected to the final learning-processing to determine and output a final class of the object.

The embedding-based object classification system and method according to the present invention as described above is advantageous in that a network for classifying so many different classes of objects (e.g., traffic signs), which is difficult to implement in an embedded environment where a memory usage amount and a computation amount are limited, can be implemented even with a limited memory usage amount and a limited computation amount by reducing the number of dimensions of output classes using the embedding layer.

In particular, by applying the embedding-based object classification system and method according to the present invention as described above to the classification of traffic signs, which is one of the essential conditions for increasing an autonomous driving level, all traffic signs can be classified without missing any class of traffic sign. Even in a case where GPS information is incorrect or map information and the actual road information are different from each other due to unexpected road construction or the like, traffic signs can be recognized, thereby providing a stable driving environment.

In addition, even when the embedding-based object classification system and method according to the present invention as described above is applied to a network for classifying various types of objects other than the traffic signs through a multi-function camera (MFC), resources can be optimized. Therefore, a complicated network can be easily applied to an embedded system, resulting in an improvement in recognition performance.

### BRIEF DESCRIPTION OF THE DRAWINGS

FIG. 1 is an exemplary diagram illustrating a configuration of an embedding-based object classification system according to an embodiment of the present invention.

FIG. 2 is an exemplary diagram illustrating a network for first learning-processing performed by an embedding-based object classification system and method according to an embodiment of the present invention.

FIG. 3 is an exemplary diagram illustrating a network for second learning-processing performed by an embedding-based object classification system and method according to an embodiment of the present invention.

FIG. 4 is an exemplary diagram illustrating final inference processing using a network last trained by an embedding-based object classification system and method according to an embodiment of the present invention.

FIG. 5 is an exemplary diagram illustrating a flowchart of an embedding-based object classification method according to an embodiment of the present invention.

### DETAILED DESCRIPTION

Hereinafter, a preferred embodiment of an embedding-based object classification system and method according to the present invention will be described in detail with reference to the accompanying drawings.

The system refers to a set of components including devices, instruments, means, and the like that are organized and regularly interact with each other to perform necessary functions.

Traffic signs are notice boards for indicating cautions, regulations, instructions, and the like necessary for traffic. In order for autonomous vehicles to obey road rules, it is one of the essential conditions to recognize signs.

However, since the traffic signs are classified into hundreds of different classes, classification is currently implemented only with respect to a specific class of traffic signs (related to the speed limit) selected to perform real-time processing in a limited cache memory capacity and a limited computation amount currently applied into a vehicle.

At autonomous driving level 3 or higher, there is no driver's intervention. Thus, if an autonomous vehicle fails to recognize all kinds of traffic signs on roads, it is not possible to safely drive while obeying flexible road rules.

In a typical classification network using a one-hot encoding method, the number of outputs is the number of classes of objects. This results in increases in memory usage amount and computation amount required for FC layers formed after a base network including a plurality of convolution layers and a plurality of pooling layers to extract features of input learning data, that is FC layers formed at the end of the classification network, making it practically impossible to implement the classification network in an embedded system.

In order to solve this problem and efficiently classify traffic signs, as an embedding-based object classification system and method according to an embodiment of the present invention, an embedding-based edge network is disclosed.

Briefly, a classification network such as ResNet or VGG16 is trained using a set of labeled learning data, and then a base network and weight values extracted therefor are applied to the classification network.

Taking into account that the base network has been trained about extracting features of objects, the classification network is configured such that the weight values obtained by the base network are fixed thereto without additionally performing learning about the same, and learning is performed once again only with respect to an embedding layer and fully-connected (FC) layers, of which the number of channels is reduced.

The embedding layer has the same internal structure as the FC layer having no bias, but in terms of purpose, converts one-hot encoded labeled information into real-number parameters in a smaller number of dimensions than the FC layer having no bias, making it possible to compress an output value in dimension through the network and reduce a memory usage amount and a computation amount required for the FC layers at the end of the network.

Although it has been described above and will be described below, to explain the embedding-based object classification system and method according to an embodiment of the present invention in an easy way, that so many different classes of objects are “traffic signs”, this is merely an example, and the embedding-based object classification system and method according to an embodiment of the present invention may be used to classify any kind of object as long as the number of classes of objects is so excessive that it is difficult to implement a classification network in an embedded system because a basically required memory usage amount and a basically required computation amount are large.

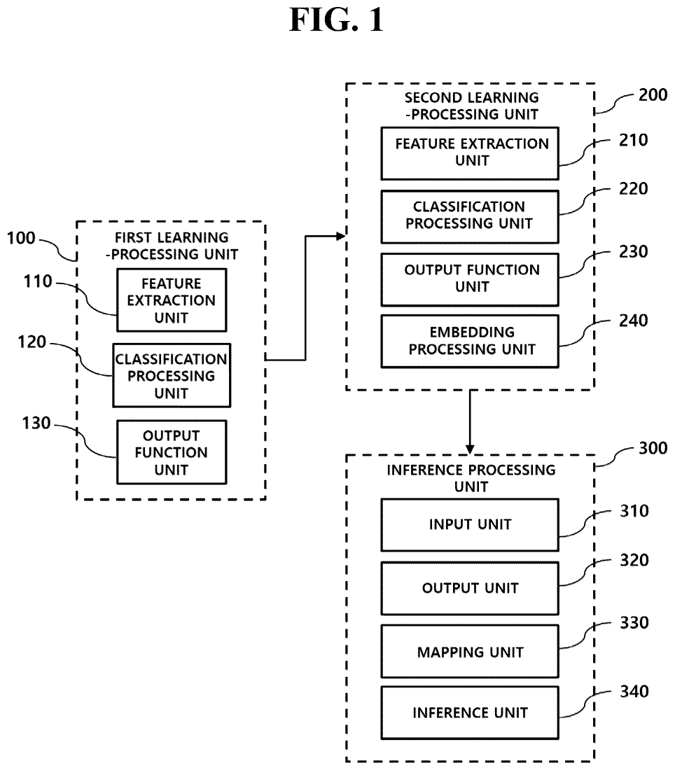

FIG. 1 illustrates a configuration diagram of an embedding-based object classification system according to an embodiment of the present invention.

As illustrated in FIG. 1, an embedding-based object classification system according to an embodiment of the present invention may include a first learning-processing unit 100, a second learning-processing unit 200, and an inference processing unit 300. An operation of each component is preferably performed through an arithmetic processing means including a computer. When each component is implemented in an embedded system to classify traffic signs as described above, its operation is performed through an arithmetic processing means such as an ECU including a computer performing transmission and reception through an in-vehicle communication channel.

Each component will be described in detail below.

The first learning-processing unit 100 performs learning by inputting a set of learning data labeled with class information for objects to a pre-stored classification network (e.g., a classification network such as ResNET or VGG16).

As illustrated in FIG. 1, the first learning-processing unit 100 includes a feature extraction unit 110, a classification processing unit 120, and an output function unit 130.

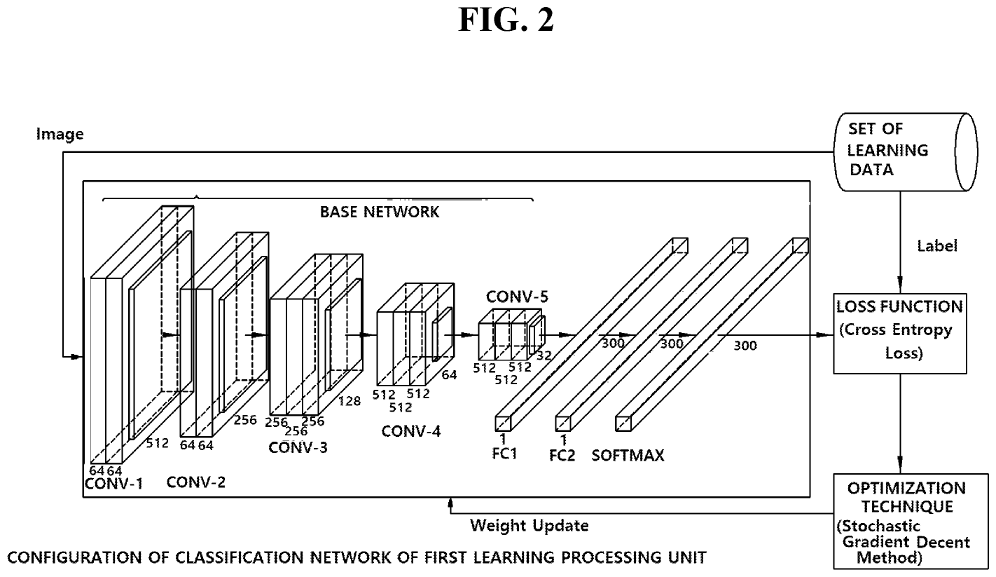

Specifically, as illustrated in FIG. 2, the classification network including a plurality of layers learns about mapping by receiving a set of learning data labeled with class information (traffic sign types) for objects (traffic signs) stored in a database.

For example, the set of labeled learning data includes 300 pieces of image data including traffic signs, respectively, and label data indicating what a traffic sign in each piece of image data means.

The feature extraction unit 110, which is a component for “feature extraction”, includes a plurality of convolution layers and a plurality of pooling layers to extract features of the set of input learning data.

The convolution layer includes one or more filters, and the number of filters indicates a depth of a channel. The more filters there are, the more image features are extracted. An image having passed through these filters has a pixel value indicating distinct features related to color, line, shape, border, and the like, and the image having passed through the filters has a feature value, which is thus called a feature map. This process is called a convolution operation. The larger number of times of convolution operation, the smaller image size and the larger number of channels.

The pooling layer is formed immediately after the convolution layer, and serves to reduce a spatial size. In this case, the reduction of the spatial size means that width and height dimensions are reduced, while a size of a channel is fixed. This makes it possible to reduce a size of input data and perform less learning, thereby reducing the number of variables and preventing an occurrence of overfitting.

The classification processing unit 120, which is a component for “classification”, includes at least two fully-connected (FC) layers at the end of the network to determine a class of a feature extracted by the feature extraction unit 110 for each piece of learning data.

In addition, the output function unit 130 determines and outputs a highest-probability class among the classes determined by the classification processing unit 120 as a final network output value using a preset activation function layer.

In this case, the output function unit 130 sets a softmax function as a preset activation function layer. The softmax function is configured for classification in a last layer by normalizing input values to values between 0 and 1 to create and output a probability distribution with the sum of 1.

The first learning-processing unit 100 updates and sets weights for the layers constituting the feature extraction unit 110 and the classification processing unit 120, based on the value output by the output function unit 130, using a preset loss function and a preset optimization technique.

That is, the loss function is used to measure how close an output of a model is to a correct answer (an actual value). The smaller the error, the smaller the loss function value. In this way, the training of the network is repeatedly performed in a direction in which the loss function value is small. In this case, the optimization technique is used when the training of the network is repeatedly performed. The optimization technique is a process of finding a weight for minimizing a loss function value, by gradually moving a weight in a direction in which an output value of a loss function decreases from a current position.

At this time, the first learning-processing unit 100 updates weights for the layers constituting the feature extraction unit 110 and the classification processing unit 120 using a cross entropy loss function as a loss function and a stochastic gradient descent method as an optimization technique. That is, the first learning-processing unit 100 classifies what label of image data a traffic sign area (a candidate area) extracted from a piece of input image data falls under among the 300 pieces of image data received through the set of learning data, and obtains a loss function between a label classification result and an actual label (correct answer data), while updating weight values for the layers constituting the network using an optimization technique so that a loss function value is minimized.

The operations performed by the feature extraction unit 110, the classification processing unit 120, and the output function unit 130 of the first learning-processing unit 100 are similar to operations performed by a conventional classification network to learn about mapping.

However, the second learning-processing unit 200 is different from the conventional classification network in learning process, although they are similar in that mapping is learned.

Specifically, the second learning-processing unit 200 configures a classification network based on a learning result of the first learning-processing unit 100, and performs learning by inputting a set of learning data labeled with class information for objects. Here, the set of learning data input to the second learning-processing unit 200 is the same as the set of learning data input to the first learning-processing unit 100.

The second learning-processing unit 200 preferably uses a base network that has been trained by the first learning-processing unit 100, so that the classification network may be implemented even with a limited memory usage amount and a limited computation amount based on embedding.

To this end, as illustrated in FIG. 1, the second learning-processing unit 200 includes a feature extraction unit 210, a classification processing unit 220, an output function unit 230, and an embedding processing unit 240.

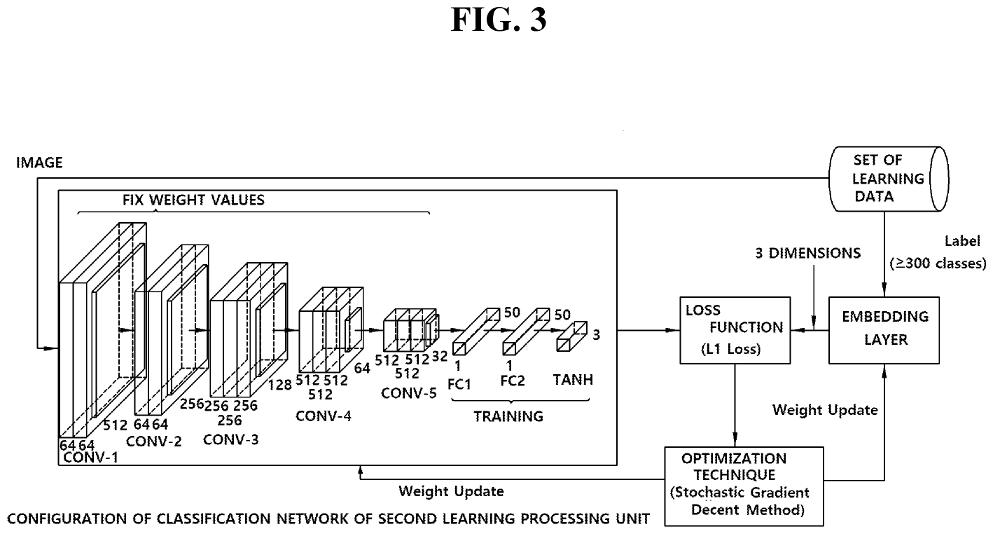

As illustrated in FIG. 3, the feature extraction unit 210, which is a component for “feature extraction”, includes a plurality of convolution layers and a plurality of pooling layers to extract features of the set of input learning data.

The convolution layer includes one or more filters, and the number of filters indicates a depth of a channel. The more filters there are, the more image features are extracted. An image having passed through these filters has a pixel value indicating distinct features related to color, line, shape, border, and the like, and the image having passed through the filters has a feature value, which is thus called a feature map. This process is called a convolution operation. The larger number of times of convolution operation, the smaller image size and the larger number of channels.

The pooling layer is formed immediately after the convolution layer, and serves to reduce a spatial size. In this case, the reduction of the spatial size means that width and height dimensions are reduced, while a size of a channel is fixed. This makes it possible to reduce a size of input data and perform less learning, thereby reducing the number of variables and preventing an occurrence of overfitting.

Meanwhile, the feature extraction unit 210 of the second learning-processing unit 200 sets weights for the plurality of convolution layers and the plurality of pooling layers included therein, using the weights set in a last (or the most recent) update by the feature extraction unit 110 of the first learning-processing unit 100.

In other words, since the base network of the first learning-processing unit 100 has been trained about extracting features of traffic signs, the base network of the second learning-processing unit 200 is configured to fix weights for the layers included therein to a result of the last (or the most recent) update performed by the first learning-processing unit 100, without repeatedly learning about the same.

Accordingly, learning areas of the second learning-processing unit 200 are limited to the classification processing unit 220 and the embedding processing unit 240.

The classification processing unit 220, which is a component for “classification”, includes at least two FC layers at the end of the network to determine a class of a feature extracted by the feature extraction unit 210 for each piece of learning data.

The embedding processing unit 240, which is the other one of the learning areas, includes at least one embedding layer, and the set of learning data input to the feature extraction unit 210 is also input to the embedding processing unit 240.

The embedding layer of the embedding processing unit 240 has the same internal structure as the FC layer having no bias, but in terms of purpose, converts one-hot encoded set of learning data into integer numbers in preset N dimensions (where N is an integer number greater than or equal to 1).

As an example of the set of labeled learning data, 300 pieces of labeled data related to traffic signs are assumed as one-hot encoded data. Here, the embedding layer of the embedding processing unit 240 converts the 300 pieces of labeled data into real-number parameters in three dimensions, which are preset dimensions.

In other words, the set of labeled learning data includes 300 pieces of labeled data, each piece of labeled data having a value of 0 or 1, which is thus considered as 300-dimensional data. The embedding layer converts the 300-dimensional data input thereto into three-dimensional data, and outputs the three-dimensional data.

That is, when 300-dimensional data is input to the embedding layer, the 300-dimensional data is converted into three-dimensional data and the three-dimensional data is output. In this case, the output after conversion into the three-dimensional data means that three real-number parameters are output.

Accordingly, the second learning-processing unit 200 obtains a loss function so that an output value of the classification network constituting the second learning-processing unit 200 is the same as the three real-number parameters output through the embedding layer, and updates weight values for the FC layers and the embedding layer constituting the network using an optimization technique so that a loss function value is minimized.

In this case, the second learning-processing unit 200 updates the weights for the layers constituting the classification processing unit 220 and the embedding processing unit 240, using an L1 loss function as a loss function and a stochastic gradient descent method as an optimization technique.

In this way, the size of the labeled data is reduced. Therefore, the FC layers included in the classification processing unit 220 of the second learning-processing unit 200 are configured in a reduced number of channels, in other words, in a smaller number of dimensions, as compared with the FC layers included in the classification processing unit 120 of the first learning-processing unit 100.

This makes it possible to compress the 300-dimensional classes of the set of learning data into three-dimensional classes through the embedding layer, thereby reducing a memory usage amount and a computation amount required for the FC layers.

The output function unit 230 outputs a class determined by the classification processing unit 220 as an output value using a preset activation function layer.

Specifically, a three-dimensional real-number value is output as a final output of the network using a hyperbolic tangent function of the preset activation function layer.

The inference processing unit 300 classifies an extracted object included in input image data, that is, image data newly input after the learning is completed, and outputs class information for the extracted object, using the classification network subjected to final learning-processing by the second learning-processing unit 200.

As illustrated in FIG. 1, the inference processing unit 300 includes an input unit 310, an output unit 320, a mapping unit 330, and an inference unit 340.

The input unit 310 inputs image data from which an object to be classified is recognized.

The output unit 320 outputs a predicted class of the object in the image data input by the input unit 310 to the classification network subjected to final learning-processing by the second learning-processing unit 200.

The mapping unit 330 performs mapping analysis by mapping a value output by the data output unit to a weight value for the embedding processing unit 240 subjected to final learning-processing by the second learning-processing unit 200.

The inference unit 340 determines and outputs a final class of the object using a mapping analysis result of the mapping unit 330. In this case, a value output by the inference unit 340 corresponds to a final classification value of the object.

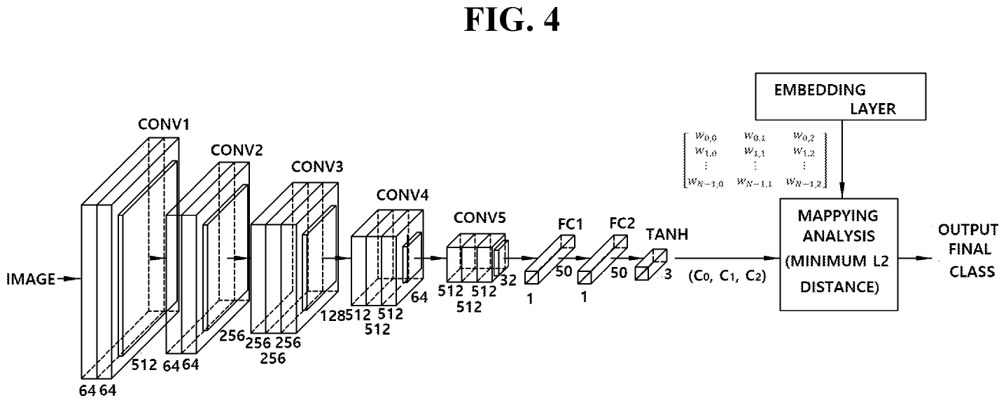

As illustrated in FIG. 4, while using the classification network subjected to final learning-processing by the second learning-processing unit 200, the inference processing unit 300 is configured to reduce a space for the output class from a very large number of dimensions (e.g., 300 dimensions) to a preset small number of dimensions (e.g., three dimensions), thereby reducing a memory usage amount and a computation amount of the deep learning classification network, making it possible to implement the deep learning classification network in an embedded system.

Specifically, since the classification network that has been trained by the second learning-processing unit 200 outputs three real-number parameters, weight values for the embedding layer are compared with the output to map an index value having a smallest distance L2 as a class value. In this case, the weight values for the embedding layer may be expressed in the form of a lookup table as illustrated in FIG. 4, and an object is classified into an item corresponding to an index value having a smallest distance L2 from the output value among approximate index values (weight values).

At this time, the classification network that has been trained by the second learning-processing unit 200 outputs three real-number parameters (c0, c1, c2) using the aforementioned activation function layer, as illustrated in FIG. 4.

In order to verify the effect of the embedding-based object classification system and method according to an embodiment of the present invention, the conventional classification network and the classification network that has been trained by the second learning-processing unit 200 were compared with each other in terms of memory usage amount and computation amount under the conditions that two FC layers are included while there are 300 traffic signs, that is, the number of classes is 300. The results are shown in Table 1 below.

TABLE 1

| | Conventional | Classification network |
|---|---|---|
| | classification | that has been trained by second |
| Item | network | learning-processing unit 200 |
| Memory usage | 720,000 | 10,600 |
| amount (MB) | | |
| Computation | 180,000 | 2,650 |
| amount (Flops) | | |

As shown in Table 1, the conventional classification network used 300 inputs/outputs in both of the two FC layers, but the classification network according to the present invention reduced its output to three dimensions and used 50 inputs/outputs in the FC layers. Accordingly, the embedding-based object classification system and method according to an embodiment of the present invention can reduce the number of dimensions of the output value itself to 1/100, making it possible to implement a network with 1.5% of the memory usage amount and 1.5% of the calculation amount of the conventional method.

This makes it possible to implement a classification network having numerous classes in an embedded system, which is advantageous in that the embedding-based object classification system and method according to an embodiment of the present invention can be efficiently utilized in various fields.

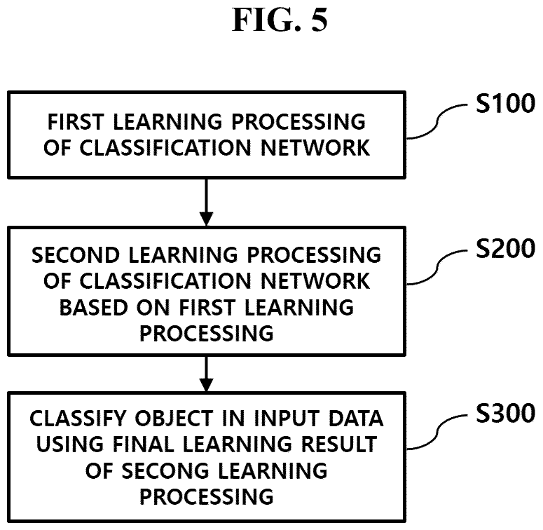

FIG. 5 is a flowchart illustrating an embedding-based object classification method according to an embodiment of the present invention.

As illustrated in FIG. 5, the embedding-based object classification method according to an embodiment of the present invention may include a first learning step (S100), a second learning step (S200), and an inference processing step (S300). Each of the steps is preferably performed using an embedding-based object classification system operated by an arithmetic processing means.

Each of the steps will be described in detail below.

In the first learning step (S100), learning is performed by inputting a set of learning data labeled with class information for objects to a pre-stored classification network.

Specifically, in the first learning step (S100), the classification network including a plurality of layers learns about mapping by receiving a set of learning data labeled with class information (traffic sign types) for objects (traffic signs) stored in a database.

In this case, the classification network of the first learning step (S100) includes a component including a plurality of convolution layers and a plurality of pooling layers to extract features of the set of input learning data, a component including at least two FC layers to determine classes of the extracted features, and a component including an activation function layer to determine a highest-probability class among the classes determined in the at least two FC layers as a final network output value.

In addition, the classification network of the first learning step (S100) updates and sets weights for the plurality of convolution layers, the plurality of pooling layers, and the at least two FC layers, based on the output value, using a preset loss function and a preset optimization technique.

That is, a loss function between the output value (a label classification result value) and the actual label (correct answer data) is obtained, while weight values for the layers constituting the network are updated using an optimization technique so that a loss function value is minimized.

In the second learning step (S200), a classification network is configured based on a learning result of the first learning step (S100), and learning is performed by inputting a set of labeled learning data.

Specifically, in the second learning step (S200), the classification network including a plurality of layers also learns about mapping by receiving a set of learning data labeled with class information (traffic sign types) for objects (traffic signs) stored in a database, while using a base network that has been trained in the first learning step (S100) as it is, so that the classification network may be implemented even with a limited memory usage amount and a limited computation amount based on embedding.

That is, the classification network of the second learning step (S200) includes a component including a plurality of convolution layers and a plurality of pooling layers to extract features of the input set of learning data, a component including at least two FC layers to determine classes of the extracted features, a component including an activation function layer to determine a highest-probability class among the classes determined in the at least two FC layers as a final network output value, and a component including an embedding layer to convert the number of dimensions of the set of learning data.

In this case, in the classification network of the second learning step (S200), the component including a plurality of convolution layers and a plurality of pooling layers to extract features of the input set of learning data sets weights for the plurality of convolution layers and the plurality of pooling layers included therein, using the weights set in a last (or the most recent) update of the first learning step (S100).

In other words, since the classification network of the first learning step (S100) has been trained about extracting features of traffic signs through the first learning step (S100), a base network area in the second learning step (S200) is configured to fix the weights for the layers included therein to a result of the last (or the most recent) update performed in the first learning step (S100), without repeatedly learning about the same.

Accordingly, learning areas in the second learning step (S200) are limited to the component including at least two FC layers to determine classes of the extracted features and the component including an embedding layer to convert the number of dimensions of the set of learning data.

In this case, the embedding layer has the same internal structure as the FC layer having no bias, but in terms of purpose, converts one-hot encoded set of learning data into integer numbers in preset N dimensions (where N is an integer number greater than or equal to 1).

As an example of the set of labeled learning data, 300 pieces of labeled data related to traffic signs are assumed as one-hot encoded data. Here, the embedding layer converts the 300 pieces of labeled data into real-number parameters in three dimensions, which are preset dimensions.

In other words, the set of labeled learning data includes 300 pieces of labeled data, each piece of labeled data having a value of 0 or 1, which is thus considered as 300-dimensional data. The embedding layer converts the 300-dimensional data input thereto into three-dimensional data, and outputs the three-dimensional data.

That is, when 300-dimensional data is input to the embedding layer, the 300-dimensional data is converted into three-dimensional data and the three-dimensional data is output. In this case, the output after conversion into the three-dimensional data means that three real-number parameters are output.

Accordingly, the classification network of the second learning step (S200) obtains a loss function so that an output value of the network is the same as the three real-number parameters output through the embedding layer, and updates weight values for the FC layers and the embedding layer constituting the network using an optimization technique so that a loss function value is minimized.

In this way, the size of the labeled data is reduced. Therefore, the FC layers included in the classification network of the second learning step (S200) are configured in a reduced number of channels, in other words, in a smaller number of dimensions, as compared with the FC layers included in the classification network of the first learning step (S100).

This makes it possible to compress the 300-dimensional classes of the set of learning data into three-dimensional classes through the embedding layer, thereby reducing a memory usage amount and a computation amount required for the FC layers.

In the inference processing step (S300), when an object to be classified is recognized from image data input from an external source, the object included in the image data is classified, and class information for the object is output, using the classification network subjected to final learning-processing in the second learning step (S200).

Specifically, in the inference processing step (S300), a predicted class of the object in the image data is output from the classification network subjected to final learning-processing in the second learning step (S200) to perform mapping analysis by mapping the output predicted class to a weight value for the embedding layer subjected to final learning-processing, such that a final class of the object is determined and output.

When an extracted object included in image data newly input after the learning is completed is classified, and class information for the extracted object is output, a space for the output class is reduced from a very large number of dimensions (e.g., 300 dimensions) to a preset small number of dimensions (e.g., three dimensions) while using the classification network subjected to final learning-processing in the second learning step (S200), thereby reducing a memory usage amount and a computation amount of the deep learning classification network, making it possible to implement the deep learning classification network in an embedded system.

In the inference processing step (S300), since the classification network subjected to final learning-processing in the second learning step (S200) outputs three real-number parameters, weight values for the embedding layer are compared with the output to map an index value having a smallest distance L2 as a class value. In this case, the weight values for the embedding layer may be expressed in the form of a lookup table as illustrated in FIG. 4, and an object is classified into an item corresponding to an index value having a smallest distance L2 from the output value among approximate index values (weight values).

The present invention is not limited to the above-described embodiment, and may be applied in a wide range. Also, various modification may be made without departing from the gist of the present invention claimed in the appended claims.

What is claimed is:

1. An embedding-based object classification system comprising:
a first learning-processing unit configured to perform first learning by inputting, to a classification network, a set of learning data labeled with class information for a plurality of objects;
a second learning-processing unit configured to (1) configure the classification network based on the learning performed by the first learning-processing unit, and (2) perform second learning by inputting the set of learning data to the classification network; and
an inference processing unit configured, using the classification network configured by the second learning-processing unit, to classify an object included in input image data and output class information of the object.

2. The embedding-based object classification system of claim 1, wherein:
the classification network of the first learning-processing unit includes:
a feature extraction unit including a plurality of convolution layers and a plurality of pooling layers and configured to extract features of the set of learning data;
a classification processing unit including a plurality of fully-connected (FC) layers and configured to determine a class of each of the extracted features; and
an output function unit including a preset activation function layer and configured to output the determined class of each extracted feature as an output value, and
the first learning-processing unit is further configured to update and set, using a preset loss function and a preset optimization technique and based on the output value from the output function unit, weights for the layers of the feature extraction unit and the classification processing unit.

3. The embedding-based object classification system of claim 2, wherein:
the classification network of the second learning-processing unit includes:
a feature extraction unit including a plurality of convolution layers and a plurality of pooling layers and configured to extract features of the set of learning data;
a classification processing unit including a plurality of FC layers and configured to determine a class of each of the extracted features;
an output function unit including a preset activation function layer and configured to output the determined class of each extracted feature as an output value; and
an embedding processing unit including at least one embedding layer and configured to convert the set of learning data into real-number parameters in a preset number of dimensions,
the weights set in a most recent update by the feature extraction unit of the first learning-processing unit are applied to the layers of the feature extraction unit of the second learning-processing unit, and
the second learning-processing unit is further configured to update and set, using a preset loss function and a preset optimization technique, weights for the FC layers of the classification processing unit and the embedding layer of the embedding processing unit of the second learning-processing unit.

4. The embedding-based object classification system of claim 3, wherein the classification processing unit of the second learning-processing unit is configured to configure the layers in a smaller number of dimensions than those of the classification processing unit of the first learning-processing unit.

5. The embedding-based object classification system of claim 3, wherein the inference processing unit includes:
an input unit configured to input image data, wherein the object to be classified is recognized from the image data;
an output unit configured to output a predicted class of the object to the classification network configured by the second learning-processing unit;
a mapping unit configured to perform mapping analysis by mapping a value output by the output unit to a weight value for the embedding processing unit according to the second learning by the second learning-processing unit; and
an inference unit configured to determine and output a class of the object using a result of the mapping analysis performed by the mapping unit.

6. An embedding-based object classification method comprising:
performing first learning by inputting, to a classification network, a set of learning data labeled with class information for objects;
configuring the classification network based on a result of the first learning, and performing second learning by inputting, to the classification network, the set of learning data; and
in response to an object to be classified being recognized from image data input from an external source, classifying the object included in the image data and outputting, using the classification network configured by the second learning, class information for the object.

7. The embedding-based object classification method of claim 6, wherein:
configuring the classification network includes applying weights for a plurality of convolution layers and a plurality of pooling layers constituting the classification network to which the set of learning data is input for performing the first learning, and
the classification network configured by the second learning includes at least one embedding layer configured to convert the set of learning data into real-number parameters in a preset number of dimensions and output the real-number parameters in the preset number of dimensions.

8. The embedding-based object classification method of claim 7, wherein the classification network configured by the second learning includes fully-connected (FC) layers in a smaller number of dimensions than those of the classification network in the first learning.

9. The embedding-based object classification method of claim 7, wherein the outputting class information for the object includes:
outputting a predicted class of the object in the image data from the classification network configured by the second learning; and
performing mapping analysis by mapping the output predicted class to a weight value for the embedding layer to determine and output a class of the object.
